(19) United States
(12) Patent Application Publication
(10) Pub. No.: US 2018/0233732 A1
(43) Pub. Date: Aug. 16, 2018

(54) BATTERY CELL CONNECTOR OF A BATTERY MODULE, METHOD FOR THE MANUFACTURE THEREOF AND BATTERY MODULE INCORPORATING THE SAME

(71) Applicant: Robert Bosch GmbH, Stuttgart (DE)

(72) Inventors: Claus Gerald Pflueger, Markgröningen (DE); Tillmann Hanser, Ludwigsburg (DE)

(21) Appl. No.: 15/896,424

(22) Filed: Feb. 14, 2018

(30) Foreign Application Priority Data
Feb. 16, 2017 (DE) 10 2017 202 512.3

(51) Int. Cl. H01M 4/13; H01M 2/26; H01M 2/30; H01M 10/0525; H01M 10/637

(52) U.S. Cl. CPC H01M 4/13; H01M 2/26; H01M 10/637; H01M 10/0525; H01M 2/30

(57) ABSTRACT

A cell connector for a battery module, having a first connecting region (21) and a second connecting region (22), and a location region (3) for a temperature sensor (7), wherein the location region (3) incorporates a first section (31) having at least one deformation region (41, 42), a second section (32), and a third section (33), which is arranged between the first section (31) and the second section (32) and is connected to the first section (31) and to the second section (32), and which is configured such that, by the deformation of the third section (33), the second section (32) at least partially closes the receptacle (8) formed by the first section (31), wherein the location region (3) for a temperature sensor (7) incorporates an opening (5) which fully penetrates at least the third section (33), and is circumferentially delimited by the location region (3).

### BACKGROUND OF THE INVENTION

The invention is based upon a generic cell connector of a battery module. A further object of the present invention is also a method for manufacturing such a cell connector, and a battery module incorporating such a cell connector.

From the prior art, it is known that batteries, specifically such as lithium-ion batteries, are comprised of at least one battery module, or are advantageously comprised of a plurality of battery modules. Preferably, a battery module further comprises a plurality of individual battery cells, which are mutually interconnected to form a battery module, wherein the individual battery cells can be mutually interconnected, in series or in parallel, by means of cell connectors.

The fitting of a temperature sensor to each of the cell connectors, for the determination of temperature, is known.

Document DE 10 2010 031 380 A1, for example, discloses a cell connector with a receptacle for a temperature sensor. The receptacle incorporates a pocket, in which the temperature sensor is accommodated. Additionally, the pocket is closed by a bracket, in order to retain the temperature sensor in the pocket. The pocket and the bracket are interconnected by means of a bracket, wherein the bracket can be curved to form the closing element. The receptacle is thus arranged on either side of the bracket.

### SUMMARY OF THE INVENTION

The cell connector of a battery module according to the invention, in comparison with cell connectors which are known from the prior art, has an advantage in that a location region for a temperature sensor can be provided, wherein mechanical loads applied to heavily mechanically-loaded regions of the location region can be reduced, and are also more evenly distributed overall.

According to the invention, a cell connector for a battery module is disclosed. The cell connector incorporates a first connecting region, which is configured as an electrically-conductive connection to a first battery cell. The cell connector moreover incorporates a second connecting region, which is configured as an electrically-conductive connection to a second battery cell.

The cell connector further incorporates a location region for a temperature sensor.

The location region incorporates a first section. The first section incorporates at least one deformation region, which is configured such that, by the deformation of the at least one deformation region of the first section, a receptacle is formed for a temperature sensor, or the first section incorporates at least one receptacle for a temperature sensor. The location region further incorporates a second section.

The location region further incorporates a third section, which is arranged between the first section and the second section and is connected to the first section and to the second section, which is configured such that, by the deformation of the third section, the second section at least partially closes the receptacle formed by the first section.

The location region for a temperature sensor thus incorporates an opening which fully penetrates at least the third section. This opening is circumferentially delimited by the location region.

The cell connector, by means of the first connecting region and the second connecting region, can be bonded to a first battery cell or to a second battery cell in an electrically-conductive manner, wherein these connections are preferably formed by material bonding, for example by welding or soldering.

Accordingly, the cell connector can electrically interconnect the first battery cell and the second battery cell, in series or in parallel.

By means of the opening which fully penetrates at least the third section, and is circumferentially delimited by the location region, it is advantageously possible to configure a mechanically stable receptacle for a temperature sensor, and simultaneously to limit the forming forces required for the purposes of fitting.

Advantageously, the cell connector is configured as a one-piece component. It is thus possible for the cell connector according to the invention to be formed in a simple manner, for example as a stamped part. Preferably, the cell connector is formed of aluminum, copper or nickel, or of a mixture of aluminum, copper and/or nickel. Specifically, the cell connector can be formed of aluminum and provided with a nickel coating. Further specifically, the cell connector can be formed of copper and provided with a nickel coating. This provides a further advantage, in that subsequent processing steps for the manufacture of the cell connector, specifically including the deformation of the deformation region of the first section, or the deformation of the third section, can be executed as simple bending processes. A temperature sensor can thus be fitted to a cell connector in a simple manner.

Appropriately, the location region for the temperature sensor incorporates a plurality of openings which respectively penetrate at least the third section, and are also respectively circumferentially enclosed by the location region. Accordingly, by means of the number of openings, it is possible to adjust the rigidity of the location region for the temperature sensor, specifically in the third section, without significantly influencing the mechanical strength thereof.

It is moreover appropriate if the opening has a cross-sectional surface. The cross-sectional surface of the opening specifically assumes a circular, elliptical, triangular, polygonal, quadrilateral or rectangular shape. It is thus possible, by means of the shape of the cross-sectional surface of the opening, and by means of the size of the opening, to adjust the rigidity of the location region for the temperature sensor, specifically in the third section, without significantly influencing the mechanical strength thereof.

Specifically, the location region of the cell connector assumes a longitudinal direction from the first section to the second section. Moreover, the location region comprises a first outer side and a second outer side, which are arranged in mutual opposition in the longitudinal direction. The third section further incorporates a first connecting section and a second connecting section, which are arranged in the longitudinal direction on mutually opposing sides of the opening.

The first connecting section terminates flush to the first outer side and/or the second connecting section terminates flush to the second outer side.

This provides an advantage, in that the first connecting section and the second connecting section, which delimit the opening on either side, specifically in the longitudinal direction of the location region for the temperature sensor, can be employed as structural elements for the enhancement of rigidity. For example, it is also possible, by means of the mutual clearance between the two connecting sections, and thus by the width of the opening, to influence the rigidity of the third section in a targeted manner. Moreover, it is thus also possible to adjust the forming forces required for the purposes of deformation during assembly, while simultaneously maintaining sufficient rigidity.

Flush fitting with an outer side provides a further advantage, in that supporting structural elements are arranged in the less heavily mechanically loaded outer regions of the third section and, moreover, the entire width of the third section, perpendicularly to the longitudinal direction, can specifically be employed for the configuration of a structural element.

The first connecting section and the second connecting section are not structurally weakened by the opening.

The invention further relates to a cell connector in a battery module. The cell connector can specifically be a cell connector of the above-mentioned type. The cell connector incorporates a temperature sensor. The temperature sensor incorporates a terminal, which is connectable or connected to a signal line.

The cell connector moreover incorporates a first connecting region, which is configured as an electrically-conductive connection to a first battery cell.

The cell connector further incorporates a second connecting region, which is configured as an electrically-conductive connection to a second battery cell.

The cell connector further incorporates a location region for a temperature sensor.

The location region incorporates a first section, which is configured as a receptacle for the temperature sensor, wherein the temperature sensor is accommodated in the receptacle.

The location region additionally incorporates a second section, which at least partially closes the receptacle with the temperature sensor contained therein. The location region moreover incorporates a third section, which is arranged between the first section and the second section, and is connected to the first section and to the second section.

The location region of the temperature sensor incorporates an opening which fully penetrates at least the third section, and which, moreover, is circumferentially delimited by the location region.

Specifically, it is also possible for the temperature sensor to be additionally provided with adhesive bonding to the receptacle. Further additionally, a thermally-conductive paste can be employed for the enhancement of thermal conductivity between the temperature sensor and the cell connector in the receptacle. Naturally, the adhesive can also be designed to increase thermal conductivity between the receptacle and the temperature sensor.

The invention further relates to a battery module having a cell connector according to the invention, and having a temperature sensor, wherein the battery module incorporates a first battery cell and a second battery cell. The first connecting region of the cell connector is connected to the first battery cell in an electrically conductive manner, and the second connecting region of the cell connector is connected to the second battery cell in an electrically conductive manner.

The invention further relates to a method for manufacturing a cell connector for a battery module, having a temperature sensor.

In a first process step, a cell connector according to the invention is provided.

Moreover, in the first process step, a temperature sensor is also provided, which incorporates a terminal which is connectable or connected to a signal line.

In a second process step, the at least one deformation region in the first section is deformed, such that a receptacle for the temperature sensor is configured.

In a third process step, the temperature sensor is accommodated in the receptacle. Thereafter, in a fourth process step, the third section of the location region is deformed such that the second section of the location region at least partially closes the receptacle, with the temperature sensor arranged therein. Accordingly, the temperature sensor can be bonded to the receptacle configured by the first section in an interference-fitted and/or a force-fitted manner.

A method of this type has an advantage, in that the cell connector can initially be manufactured by a simple method, as a stamped part, and the receptacle for the temperature sensor can be simply achieved by forming processes such as, for example, bending processes.

### BRIEF DESCRIPTION OF THE DRAWINGS

Exemplary embodiments of the invention are represented in the drawings, and are described in greater detail in the following description.

FIG. 1 shows a schematic overhead view of one form of embodiment of a cell connector according to the invention,

FIG. 2 shows a perspective view of one form of embodiment of a cell connector according to the invention, with a temperature sensor,

FIG. 3 shows a further perspective view of the form of embodiment of the cell connector according to the invention represented in FIG. 2, without a temperature sensor,

FIG. 4 shows a further perspective view of the form of embodiment of the cell connector according to the invention represented in FIG. 2, with a temperature sensor,

FIG. 5a shows a sectional view of the location region of the cell connector, without a temperature sensor,

FIG. 5b shows a sectional view of the location region of the cell connector, with a temperature sensor,

FIGS. 6a, b, c, d show perspective views of a cell connector at different points in time during a manufacturing method according to the invention.

### DETAILED DESCRIPTION

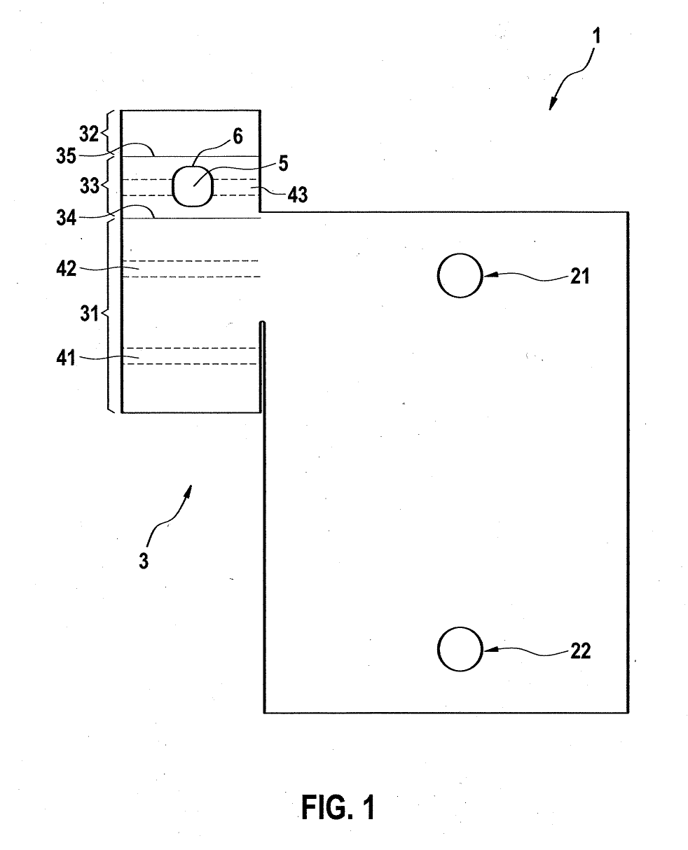

FIG. 1 shows a schematic overhead view of one form of embodiment of a cell connector 1 according to the invention.

The cell connector 1 incorporates a first connecting region 21, which is configured as an electrically-conductive connection to a first battery cell, which is not represented here.

The cell connector 1 incorporates a second connecting region 22, which is configured as an electrically-conductive connection to a second battery cell, which is not represented here.

At this point, it should be observed that the first battery cell or the second battery cell are specifically connected, in an electrically-conductive manner, to the side of the first connecting region 21 or the second connecting region 22 which is arranged opposite to the side which can be seen in FIG. 1.

The cell connector 1 further incorporates a location region 3 for a temperature sensor, which is described in greater detail hereinafter.

The location region 3 comprises a first section 31, a second section 32 and a third section 33. In the interests of a clearer understanding of the potential mutual delimitation of the sections 31, 32, 33, solid lines 34, 35 are plotted for exemplary purposes, which otherwise have no further physical significance.

The line 34 thus delimits the first section 31 from the third section 33, and the line 35 delimits the second section 32 from the third section 33.

From FIG. 1, it will thus be seen that the third section 33 is arranged between the first section 31 and the second section 32. From FIG. 1, it will also be seen that the third section 33 is respectively connected to the first section 31 and to the second section 32. Specifically, the location region 3 is configured as a one-piece component. Moreover, the cell connector 1 is also specifically configured as a one-piece component.

The first section 31, according to the exemplary embodiment represented in FIG. 1, moreover incorporates a first deformation region 41 and a second deformation region 42. The first section 31 is configured such that, by a deformation of the first deformation region 41 and of the second deformation region 42 of the first section 31, a receptacle can be configured for a temperature sensor.

At this point, it should be observed that the deformation regions 41, 42 are respectively represented by a dashed line.

Moreover, it is also possible that the location region 3 already comprises a receptacle for a temperature sensor, which is not represented in FIG. 1, but which can be seen from the following figures.

The third section 33 incorporates an opening 5, which is configured to fully penetrate the third section 33 and which, as can be seen from FIG. 1, is circumferentially delimited by the location region 3.

By this, it is to be understood that a circumference 6 of the opening 5 is entirely configured by the location region 3.

The third section 33 moreover incorporates a deformation region 43, which is indicated by the dashed line. By means of a deformation of the third section 33, specifically of the deformation region 43, the second section 32 can at least partially close the receptacle for the temperature sensor which is configured by the first section 31, as described in greater detail with reference to the following figures.

The exemplary embodiment of the cell connector 1 represented in FIG. 1 can be configured in a simple manner, for example as a stamped part.

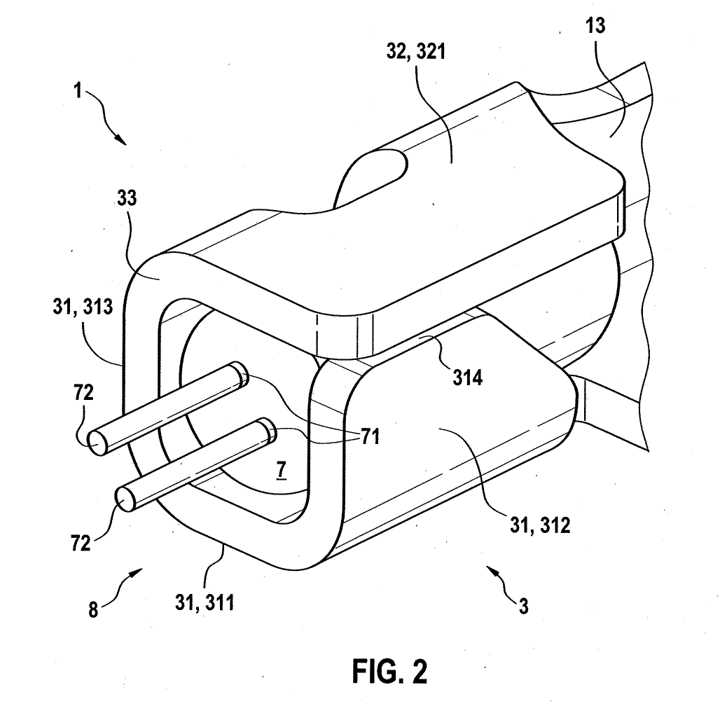

FIG. 2 shows a perspective view of one form of embodiment of a cell connector 1 according to the invention, with a temperature sensor 7.

The temperature sensor 7 comprises at least one terminal 71, which is connected to a signal line 72.

The first section 31 of the location region 3 constitutes a receptacle 8 for the temperature sensor 7. Moreover, the second section 32 at least partially closes the receptacle 8.

At this point, it should be observed that the second section 32 only at least partially closes the receptacle 8 such that, specifically, the signal line 72 can be routed out of the receptacle 8.

At this point, the design of the location region 3 will be addressed in further detail.

The first section 31 constitutes the receptacle 8 for the temperature sensor 7, wherein the receptacle 8 incorporates a base region 311 and two opposing, and specifically also mutually parallel-oriented side regions 312, 313.

The second section 32, which at least partially closes the receptacle 8, incorporates a cover region 321, which is preferably arranged parallel to the base region 311.

Moreover, the cover region 321 is specifically arranged at right-angles to the two side regions 312, 313.

The third section 33 of the location region 3 is specifically connected to the cover region 321 and to the base region 313.

Moreover, the cover region 321 can preferably engage with an upper side 314 of the side region 312.

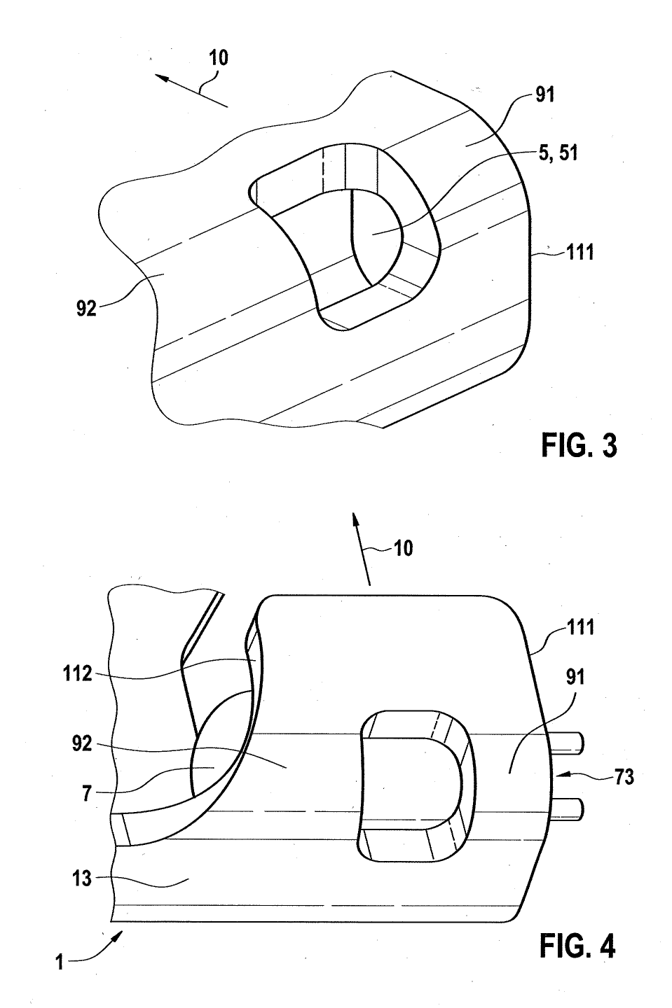

FIG. 3 shows a perspective view of the form of embodiment of the cell connector 1 according to FIG. 2, wherein the representation of the temperature sensor 7 is omitted and, specifically, the opening 5 is visible. It will be seen that the opening 5 is initially configured with a rectangular cross-sectional surface 51, with rounded corners.

Moreover, from the representation according to FIG. 3, it will be seen that the location region 3 incorporates a first connecting section 91 and a second connecting section 92, which are arranged in a longitudinal direction 10 of the location region 3, on mutually opposing sides of the opening 5.

The first connecting section 91 and the second connecting section 92 thus increase the rigidity of the location region 3.

Moreover, it will also be seen from FIG. 3 that the location region 3 incorporates a first outer side 111, wherein the first connecting section 91 terminates flush to the first outer side 111.

From FIG. 4, represented thereafter, it will also be seen that the location region 3 incorporates a second outer side 112, which is arranged in opposition to the first outer side 111, in the longitudinal direction 10, wherein the second connecting section 92 terminates flush to the second outer side 112.

FIG. 4 shows a perspective view of the cell connector 1 according to FIGS. 2 and 3, with a temperature sensor 7, which is accommodated in the receptacle 8 of the location region 3.

At this point, it should be observed that a longitudinal direction 73 of the temperature sensor 7 is specifically arranged perpendicularly to the longitudinal direction 10 of the location region 3.

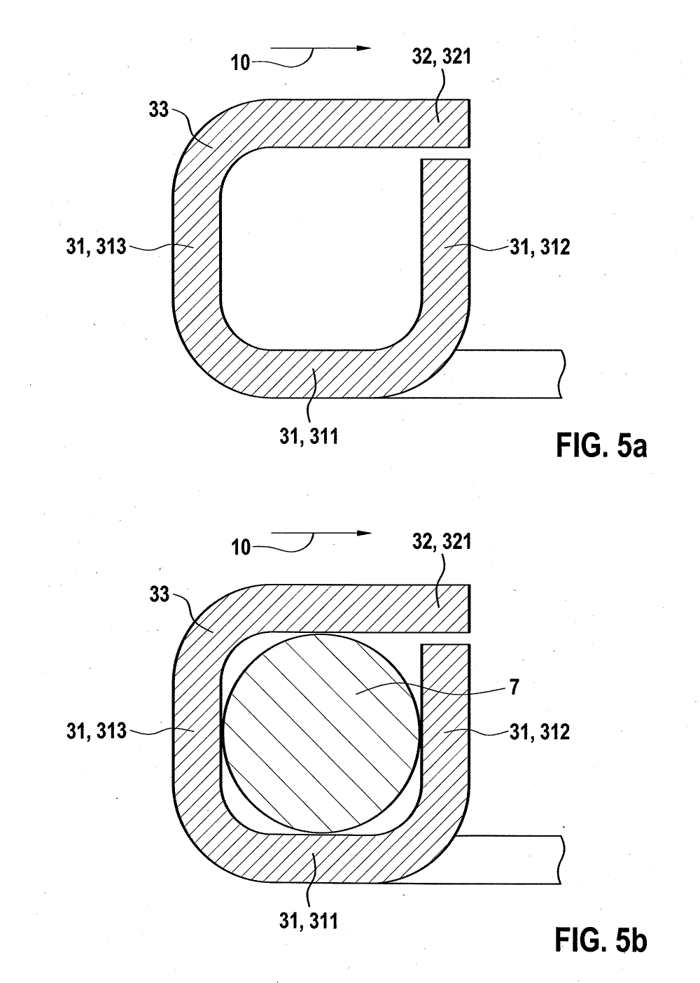

FIGS. 5a and 5b respectively show a sectional view of the location region 3 of the cell connector 1, wherein each of the sectional views represents a plane which is parallel to the longitudinal direction 10 of the location region 3.

FIG. 5a shows a view with the temperature sensor omitted, and FIG. 5b shows a view in which a temperature sensor 7 is accommodated in the receptacle 8.

Specifically, in the representation shown in FIGS. 5a and 5b, the cover region 321, the base region 311 and the two side regions 312, 313 can be seen. Again, it will be seen that the two side regions 312, 313 are arranged parallel to each other, and that the cover region 321 and the base region 311 are also arranged parallel to each other.

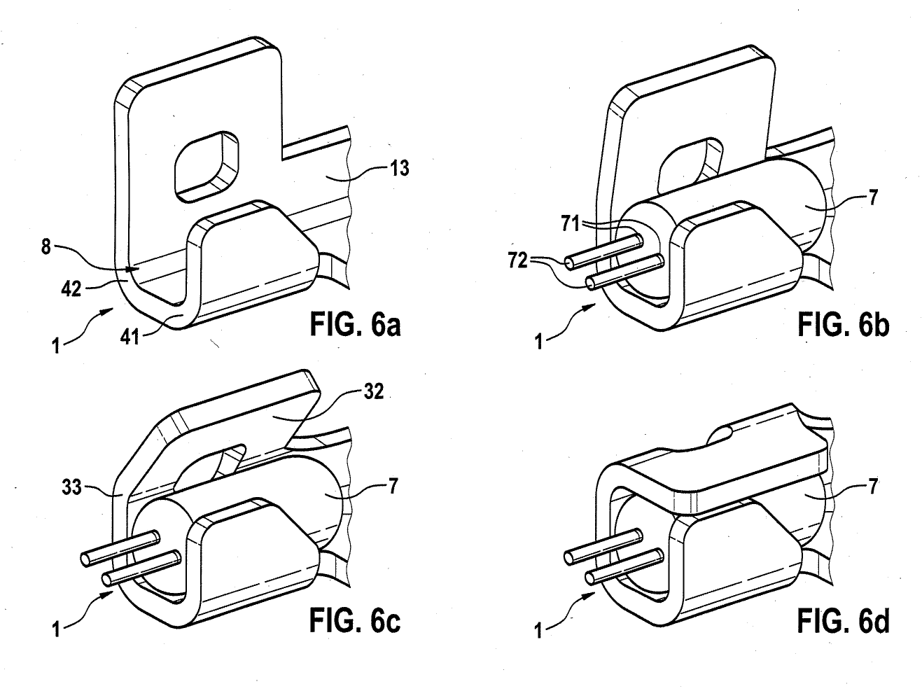

FIGS. 6a, 6b, 6c and 6d respectively show perspective views of a cell connector 1 according to the invention, at different time points in a method according to the invention.

In a first process step of the method according to the invention, a cell connector 1 according to the invention is provided, and a temperature sensor 7 is provided, having a terminal 71 which is connectable or connected to a signal line 72. A cell connector 1 of this type is specifically represented in FIG. 1.

In a second process step, the first deformation region 41 and the second deformation region 42 are deformed, such that the first section 31 constitutes a receptacle 8 for the temperature sensor 7.

FIG. 6a represents the cell connector 1 after the execution of the second process step.

In a third process step, the temperature sensor 7 is accommodated in the receptacle 8 thus constituted.

FIG. 6b shows the cell connector 1, with the temperature sensor 7, after the execution of the second process step.

In a fourth process step, the third section 33 of the location region 3 is deformed, such that the second section 32 of the location region 3 at least partially closes the receptacle 8.

FIG. 6c shows the cell connector 1, with the temperature sensor 7, during the fourth process step, and FIG. 6d shows the cell connector 1, with the temperature sensor 7, after the execution of the fourth process step.

Specifically, from FIGS. 2, 4 and 6a, it will be seen that the cell connector 1 can further incorporate a reinforcing region 13, which is connected to the location region 3, specifically to the first section 31, and further specifically to the side region 313 thereof, and can increase the stability of the receptacle 8.

1. A cell connector for a battery module, comprising
a first connecting region (21), configured as an electrically-conductive connection to a first battery cell, and
a second connecting region (22), configured as an electrically-conductive connection to a second battery cell, and
a location region (3) for a temperature sensor (7), wherein the location region (3) incorporates a first section (31) having at least one deformation region (41, 42), which is configured such that, by the deformation of the at least one deformation region (41, 42) of the first section (31), a receptacle (8) is formed for a temperature sensor (7), or incorporating at least one receptacle (8) for a temperature sensor (7), wherein the location region (3) further incorporates a second section (32), wherein the location region (3) incorporates a third section (33), which is arranged between the first section (31) and the second section (32) and is connected to the first section (31) and to the second section (32), and which is configured such that, by means of a deformation of the third section (33), the second section (32) at least partially closes the receptacle (8) formed by the first section (31),
wherein the location region (3) for a temperature sensor (7) thus incorporates an opening (5) which fully penetrates at least the third section (33), and is circumferentially delimited by the location region (3).

2. The cell connector according to the preceding claim 1, characterized in that the cell connector (1) is configured as a one-piece component.

3. The cell connector according to claim 1, characterized in that the location region (3) for the temperature sensor (7) incorporates a plurality of openings (5) which respectively penetrate at least the third section (33), and are also respectively circumferentially enclosed by the location region (3).

4. The cell connector according to claim 1, wherein the opening (5) has a cross-sectional surface (6), characterized in that the cross-sectional surface (6) specifically assumes a circular, elliptical, triangular, polygonal, quadrilateral or rectangular shape.

5. The cell connector according to claim 1, wherein the location region (3) assumes a longitudinal direction (10) from the first section (31) to the second section (32), and the location region (3) comprises a first outer side (111) and a second outer side (112), which are arranged in mutual opposition in the longitudinal direction (10), and the third section (33) incorporates a first connecting section (91) and a second connecting section (92), which are arranged in the longitudinal direction (10) on mutually opposing sides of the opening (5), characterized in that the first connecting section (91) terminates flush to the first outer side (111) and/or the second connecting section (92) terminates flush to the second outer side (112).

6. A cell connector for a battery module, wherein the cell connector (1) comprises
a temperature sensor (7) having a terminal (71) which is connectable or connected to a signal line (72),
a first connecting region (21), which is configured as an electrically-conductive connection to a first battery cell,
a second connecting region (22), which is configured as an electrically-conductive connection to a second battery cell, and
a location region (3) for a temperature sensor (7), wherein the location region (3) incorporates a first section (31), which is configured as a receptacle (8) for the temperature sensor (7),
wherein the temperature sensor (7) is accommodated in the receptacle (8),
wherein the location region (3) incorporates a second section (32), which at least partially closes the receptacle (8), and the location region (3) moreover incorporates a third section (33), which is arranged between the first section (31) and the second section (32), and is connected to the first section (31) and to the second section (32), and
wherein the location region (3) of the temperature sensor (7) incorporates an opening (5) which fully penetrates at least the third section (33), and which, moreover, is circumferentially delimited by the location region (3).

7. A battery module with a cell connector according to claim 6, wherein the battery module further comprises a first battery cell and a second battery cell, wherein the first connecting region (21) of the cell connector (1) is connected to the first battery cell in an electrically conductive manner, and the second connecting region (22) of the cell connector (1) is connected to the second battery cell in an electrically conductive manner.

8. A process for manufacturing a cell connector of a battery module having a temperature sensor, the method comprising
in a first process step, providing a cell connector (1) according to claim 1, and providing a temperature sensor (7) which incorporates a terminal (71) connectable or connected to a signal line (72),
in a second process step, deforming the at least one deformation region (41, 42) in the first section (31) such that a receptacle (8) for the temperature sensor (7) is configured,
in a third process step, accommodating the temperature sensor (7) in the receptacle (8), and
in a fourth process step, deforming the third section (33) of the location region (3) such that the second section (32) of the location region at least partially closes the receptacle (8).
